(19) United States
(12) Patent Application Publication
(10) Pub. No.: US 2006/0125947 A1
(43) Pub. Date: Jun. 15, 2006

(54) Imaging with clustered photosite arrays

(76) Inventors: Jimmy L. Packer, Lebanon, OR (US); Matthew M. Borg, Albany, OR (US); Tim G. Brown, Corvallis, OR (US); Donald M. Reid, Corvallis, OR (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/008,451

(22) Filed: Dec. 9, 2004

(51) Int. Cl. H04N 5/225

(52) U.S. Cl. 348/340

(57) ABSTRACT

Systems and methods of imaging with clustered photosite arrays are described. In one aspect, an image sensor includes an array of clusters of photosites and an array of optical elements. The photosites are arranged in respective groups of multiple ones of the photosites sharing at least one readout circuit component. Each of the optical elements is aligned with a corresponding one of the clusters of photosites and is arranged to intercept light directed toward the photosites of the corresponding cluster.

### BACKGROUND

Image sensors typically include a one-dimensional linear array or a two-dimensional array of photosites (i.e., light sensitive regions, often referred to as “pixels”) that generate electrical signals that are proportional to the intensity of the light respectively received in the light sensitive regions. Solid-state image sensors are used in a wide variety of different applications, including digital still cameras, digital video cameras, machine vision systems, robotics, guidance and navigation applications, and automotive applications.

One class of image sensors is based on charge-coupled device (CCD) technology. In a common implementation, a CCD image sensor includes an array of closely spaced metal-oxide-semiconductor (MOS) diodes. In operation, a sequence of clock pulses is applied to the MOS diodes to transfer charge across the imaging area.

Another class of image sensors is based on active pixel sensor (APS) technology. Each pixel of an APS image sensor includes a light sensitive region and sensing circuitry. The sensing circuitry includes an active transistor that buffers the electrical signals generated by the associated light sensitive region. In a common implementation, APS image sensors are made using standard complementary metal-oxide-semiconductor (CMOS) processes, allowing such image sensors to be readily integrated with standard analog and digital integrated circuits. In a common three-transistor (3T) design, each CMOS APS image sensor pixel includes an imaging device (e.g., a photodiode), a source follower transistor, a readout transistor, and a row selection transistor.

Recently, APS image sensors have been developed in which adjacent pixels share readout circuit components so that the overall amount of readout circuitry is reduced. In a typical design, the image sensor includes an array of cells each of which includes a photosite and associated readout circuitry. The cells are arranged so that at least some of the readout circuitry of adjacent cells is shared. In this design, the photosites are not uniformly distributed across the image sensor, but rather the photosites are distributed in clusters across the image sensor.

Typically, each photosite of an image sensor is associated with a respective color filter and a respective lens (or microlens) that focuses light onto the photosites. In image sensors that have a uniform distribution of photosites, the color filters and lenses are centered over corresponding ones of the photosites to achieve optimal light collection and color separation results. In image sensors that have a clustered distribution of photosites, however, the color filters and lenses cannot be centered over corresponding ones of the photosites. As a result, hitherto, less than optimal light collection and color separation results have been achieved with these types of image sensors.

### SUMMARY

In one aspect, the invention features an image sensor that includes an array of clusters of photosites and an array of optical elements. The photosites are arranged in respective groups of multiple ones of the photosites sharing at least one readout circuit component. Each of the optical elements is aligned with a corresponding one of the clusters of photosites and is arranged to intercept light directed toward the photosites of the corresponding cluster.

In another aspect, the invention features an image sensing method. In accordance with this inventive method, light is divided into an array of light beams. The light beams are sensed at corresponding ones of clusters of photosites. Signals are generated from the sensed light beams. The signals are read through sets of readout circuitry shared by respective groups of multiple ones of the photosites.

In another aspect, the invention features a method of making an image sensor. In accordance with this inventive method, an array of cells is formed and an array of optical elements is formed. Each cell includes a respective photosite. Adjacent ones of the cells are arranged into respective groups of cells each sharing at least one readout circuit component. Adjacent groups of cells form clusters of photosites. Each optical element is aligned with a corresponding one of the clusters of photosites and is arranged to intercept light directed toward the photosites of the corresponding ones of the clusters.

Other features and advantages of the invention will become apparent from the following description, including the drawings and the claims.

### DESCRIPTION OF DRAWINGS

FIG. 1 is a diagrammatic top view of a portion of a clustered array of photosites in a prior art implementation of an image sensor.

FIG. 2 is a diagrammatic sectional view of a photosite in the image sensor implementation shown in FIG. 1

FIG. 3 is a circuit diagram of a prior art implementation of shared readout circuitry for a group of four of the photosites in the clustered array shown in FIG. 1.

FIG. 4 is a timing diagram for an exemplary correlated double sampling method of reading out a pixel value.

FIG. 5 is an exploded diagrammatic view of a portion of an embodiment of an image sensor that includes a lens and a color filter that are aligned with a corresponding photosite cluster in the clustered array shown in FIG. 1.

FIG. 6 is a diagrammatic sectional view of the portion of the image sensor embodiment shown in FIG. 5.

FIG. 7 is a flow diagram of an embodiment of an image sensing method.

FIG. 8 is a diagrammatic sectional view of a portion of an embodiment of an image sensor that includes an array of lenses arranged to improve lateral recapture of incoming light.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

The embodiments that are described in detail below include an arrangement of optical elements over a clustered array of photosites that trades color resolution for improvements in light collection efficiency and color separation efficiency. These embodiments also allow the lenses of image sensors that employ clustered photosite arrays to be arranged in a way that compensates for off-normal light incidence without causing severe color artifacts. In addition, these embodiments reduce the complexity of implementing reduced-resolution operational modes (e.g., monitor or viewfinder modes) for image sensors that employ clustered photosite arrays.

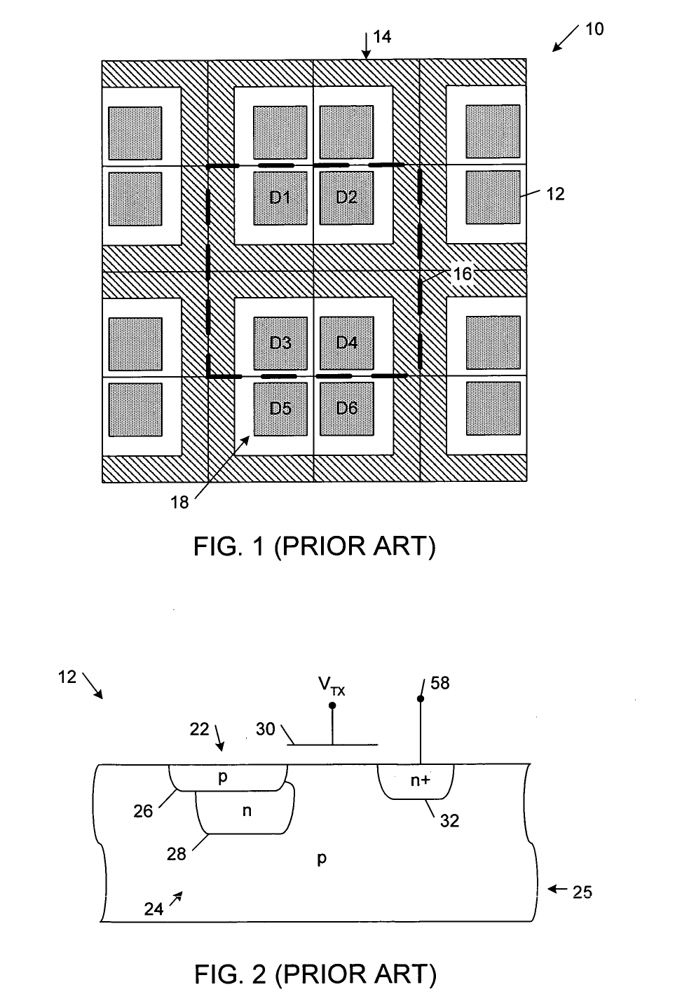

FIG. 1 shows a portion of a clustered array 10 of photosites 12 in a prior art implementation of an image sensor. The clustered array 10 is formed from an array of unit cells 14. Each unit cell 14 consists of a respective photosite 12 and associated readout circuitry (located in areas highlighted by cross-hatching). The unit cells 14 are arranged so that the photosites in adjacent cells 14 share at least one readout circuit component. In the illustrated implementation, each of the photosites 12 is a member of a respective group 16 of four photosites 12 (one such group of photosites D1, D2, D3, and D4 is shown within the dashed box) that share at least one readout circuit component (e.g., at least one of a row select transistor, a source follower transistor, and a reset transistor). In this way, the amount of readout circuitry is reduced and the amount of area that is available for the photosites is increased. In order to achieve this efficient utilization of readout circuitry, however, the photosites 12 are located asymmetrically within the respective cells 14 and the orientations of the cells 14 results in clusters 18 of photosites 12, where each cluster 18 consists of four photosites 12 (e.g., the cluster containing the photosites D3, D4, D5, and D6). As a result, the photosites 18 are not uniformly distributed across the image sensor.

FIG. 2 shows an implementation of a photosite 12 that includes a pinned photodiode 22 formed in a region 24 of a substrate 25. In the illustrated implementation, the region 24 of the substrate 25 is doped p-type and the pinned photodiode 22 includes a p-type region 26 and an n-type region 28 that are formed in the p-type region 24. The photosite 12 also includes a transfer gate 30 and a floating diffusion region 32.

Substrate 25 may be a semiconductor substrate (e.g., silicon) and the structures that are formed in substrate 24 may be fabricated in accordance with any semiconductor device fabrication process, including CMOS, bipolar CMOS (BiCMOS), and bipolar junction transistor fabrication processes. The n-type region 28 may be formed by doping the substrate 25 with an n-type dopant (e.g., phosphorous in the case of a silicon substrate 25). The p-type regions 24, 26 may be formed by doping the substrate 25 with a p-type dopant (e.g., boron in the case of a silicon substrate 25).

Additional details regarding the structure, operation, and alternative implementations of image sensor 10 may be obtained from U.S. Pat. No. 6,320,617.

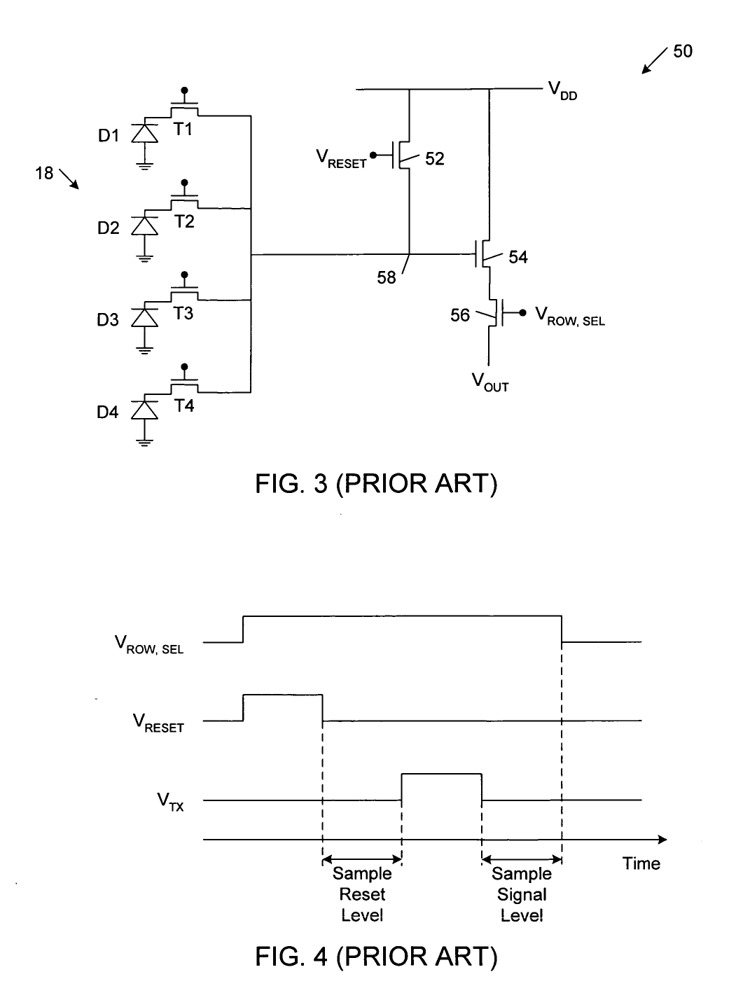

FIG. 3 shows an embodiment of the readout circuitry 50 for each group 16 of four photosites in the clustered photosite array 10. Among the readout circuit components that are shared by the photosites in each group are a reset transistor 52, a source-follower transistor 54, and a row select transistor 56. The drains of the reset and source-follower transistors 52, 54 are electrically connected to a high voltage rail (V_{DD}) of a bias circuit. In this embodiment, each photosite is implemented by a respective photodiode D1, D2, D3, and D4. The anodes of the photodiodes D1-D4 are electrically connected to ground. The gates of the reset and row select transistors 52, 56 are controlled by control signals V_{RESET} and V_{ROW, SEL}, respectively. The cathodes of the photodiodes D1-D4 are connected to a sample node 58 through respective transfer gates T1, T2, T3, and T4.

FIG. 4 shows a timing diagram of the control signals in a cycle of a correlated double-sampling method of operating the clustered photosite array 10. In this method, the voltage that is applied across the photodiodes D1-D4 by the bias circuit 58 is a fixed reverse bias voltage (i.e., V_{DD}>0). In this method, the photodiodes are reset to their pinning voltage by pre-charging the floating diffusion 32 to a fixed bias voltage (i.e. V_{DD}>0) and then transferring charge from the floating diffusion to the selected photodiode via the coresponding transfer gate. Initially, a selected one of the photodiodes D1-D4 is reset by setting V_{RESET} high, and then setting the corresponding transfer gate T1-T4 high. This operation depletes the photodiode of electrons, thus raising its reverse bias potential to the pinning voltage. Then, while the photodiode is allowed to integrate, photo-generated electrons are captured by the electric field across the photodiode, causing the reverse bias potential across the photodiode to decrease. At the end of the integration period, V_{RESET} is set high again as shown in FIG. 4 to reset the floating diffusion node 58 to the reset potential. The reset potential is sampled at V_{OUT} via the pixel source follower 54. The corresponding transfer gate then is toggled high and low to transfer all of the captured electrons from the photodiode to the floating diffusion node 58. In this process, the photodiode is returned to the pinning voltage. The electrons that are shifted to the floating diffusion node 58 reduce the floating diffusion potential to the “signal” level. The signal level then is sampled at V_{OUT}. The difference between the sampled reset potential and the sampled signal potential corresponds to the illumination level of the selected photodiode. The process may be repeated for each of the photodiodes D1-D4.

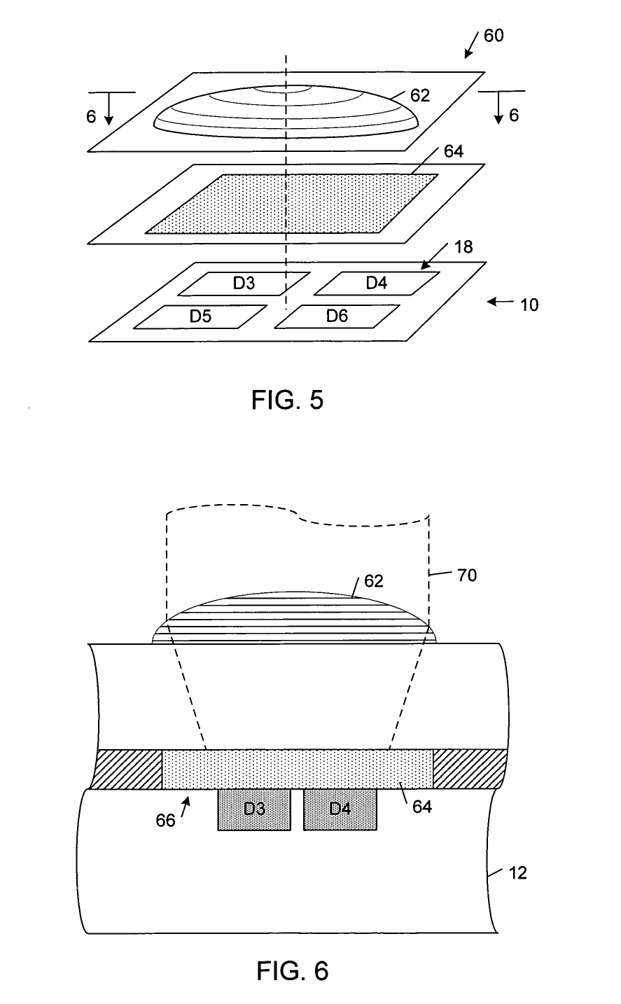

FIGS. 5 and 6 show a portion of an embodiment of an image sensor 60 that incorporates the clustered photosite array 10. For each cluster 18 of photosites the image sensor 60 includes a respective lens 62, and a respective color filter 64. The lens 62 and the color filter 64 are aligned with the corresponding photosite cluster 18 and are arranged to intercept the incoming light 70 and to direct light of a particular color (e.g., a color selected from red, green, and blue) to the photosites of the corresponding cluster 18. In this way, each cluster 18 of photosites 12 in the image sensor 60 images a respective color of light that is received from a scene.

The lens 62 is configured to focus incoming light 70 onto the photosites of the corresponding cluster 18. The lens 62 may be part of a microlens array that is distributed across a surface of the image sensor 60.

The color filter 64 allows only a relatively narrow radiation wavelength range (e.g., a color in the visible spectrum, such as red, green, and blue) to reach the photosites of the corresponding cluster 18. Multiple sets of color filters 64 of different colors typically are arranged across the image sensor 60 in a pattern (e.g., a Bayer pattern) of cluster-size mosaics or cluster-wide stripes. The color filters 64 typically are formed from a photoresist structure that includes a layer for each filter color. A common color filter material is spin-coated photoresist, dyed photoresist, or pigmented photoresist. The filter colors for a given color filter set may be additive (e.g., red, green, blue) or subtractive (e.g., cyan, magenta, yellow), or a combination of both additive and subtractive.

The grouping of pixels of the same color enables pixels in the same color plane to be readily averaged for reduced-resolution operational modes (e.g., monitor or viewfinder modes). For example, in one implementation, all of the transfer gates in each cluster may be set high during a readout cycle so that the signals from all four photosites in each cluster are sampled at the same time, and the resulting output voltage represents the average of the four pixels in the corresponding cluster. The results of this approach are less noisy and are of higher resolution than sub-sampling based approaches for implementing reduced-resolution operational modes.

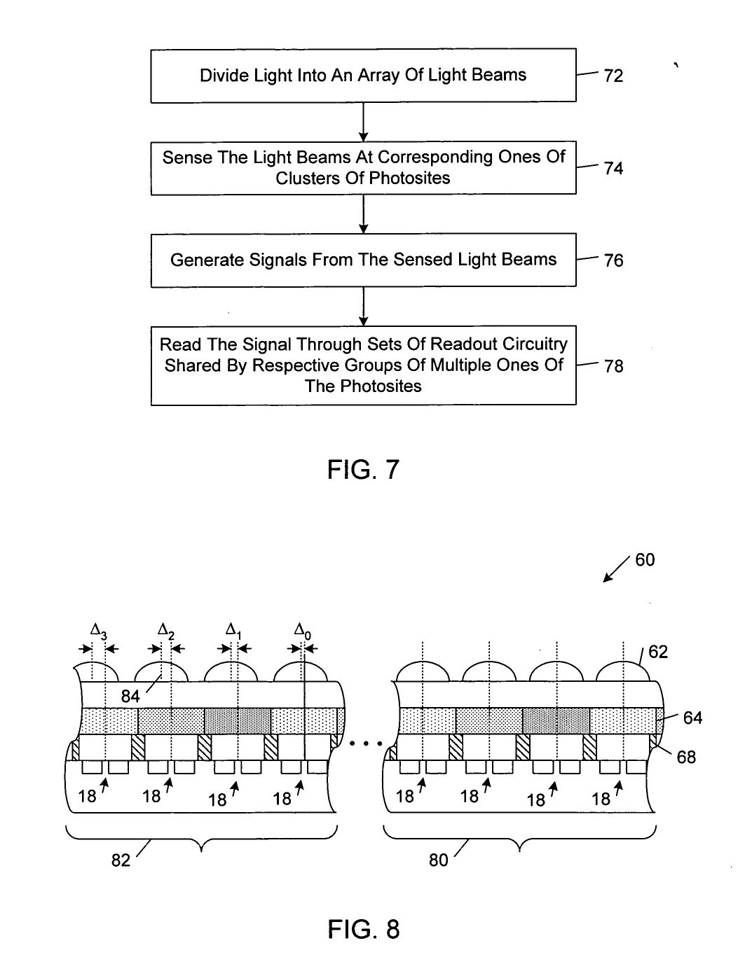

FIG. 7 shows an embodiment of an image sensing method that is implemented by the image sensor 60. The lenses 62 and the color filters 64 divide the incoming light 70 into an array of light beams (block 72). In particular, the lenses focus the light beams on the photosites 12 of corresponding ones of the clusters 18. The color filters 64 allow respective colors of light to pass through to the photosites 12 of corresponding ones of the clusters 18. The photodiodes at the photosites 12 sense the light beams at corresponding ones of the clusters 18 (block 74). The photodiodes generate signals from the sensed light beams (block 76). The signals are read through the sets of readout circuitry shared by the corresponding groups 18 of photosites 12 (block 78).

Referring to FIG. 8, in some embodiments, the lenses 62 and the color filters 64 in a central portion 80 of the image sensor 60 are aligned with the centers of the corresponding clusters 18. In peripheral portions 82 of the image sensor 60, the lenses 62 and the color filters 64 are shifted with respect to the centers of the corresponding clusters 18 to compensate for off-normal light incidence without causing severe color artifacts. In the illustrated embodiment, the optical axes 84 of the lenses 62 in the peripheral portions 80 of the image sensor 60 are shifted by offset amounts (Δ₀, Δ₁, Δ₂, Δ₃) that increase progressively with the distance from the center of the image sensor (i.e., Δ₀<Δ₁<Δ₂<Δ₃) The optical axes 84 of the color filters 64 in the peripheral portions 80 of the image sensor 60 typically also are shifted by offset amounts that increase progressively with the distance from the center of the image sensor; the offset amounts for the color filters 64, however, typically are different from the offset amounts for the lenses due to the different relative heights of the lenses 62 and color filters 64 above the photodiodes. The offset amounts for the lenses 62 and the color filters 64 may be determined using any type of off-normal light incidence compensation technique. In some implementations, the respective offset amounts for lenses 62 and color filters 64 that are equidistant from the center of the image sensor 60 are substantially the same.

Other embodiments are within the scope of the claims. For example, in the embodiments described above, each of the clusters 18 in the clustered photosite array 10 consists of four photosites. In other embodiments, each of the clusters may contain a different number (e.g., two, three, or more than four) of photosites.

What is claimed is:

1. An image sensor, comprising:
an array of clusters of photosites arranged in respective groups of multiple ones of the photosites sharing at least one readout circuit component; and
an array of optical elements each aligned with a corresponding one of the clusters of photosites and arranged to intercept light directed toward the photosites of the corresponding cluster.

2. The image sensor of claim 1, wherein the photosites are laid out in respective, substantially identical cells.

3. The image sensor of claim 2, wherein the photosites are located asymmetrically within the respective cells.

4. The image sensor of claim 1, wherein the photosites in each of the groups share at least one readout circuit component selected from: a row select transistor; a source follower transistor; and a reset transistor.

5. The image sensor of claim 1, wherein each of the clusters consists of at least two photosites.

6. The image sensor of claim 5, wherein each of the clusters consists of four photosites.

7. The image sensor of claim 1, wherein distances separating photosites in a common cluster are smaller than distances separating photosites in different respective clusters.

8. The image sensor of claim 1, wherein the optical elements are color filters configured to allow respective colors of light to pass through to the photosites of the corresponding ones of the clusters.

9. The image sensor of claim 8, further comprising an array of lenses each aligned with a corresponding one of the color filters.

10. The image sensor of claim 9, wherein each lens is configured to focus light onto the photosites of a corresponding one of the clusters.

11. The image sensor of claim 1, wherein the optical elements are lenses.

12. The image sensor of claim 11, wherein each lens is configured to focus light onto the photosites of a corresponding one of the clusters.

13. The image sensor of claim 12, wherein at least a portion of the lenses are arranged with optical axes substantially aligned with centers of corresponding ones of the clusters of photosites.

14. The image sensor of claim 13, wherein a peripheral portion of the lenses are arranged with optical axes offset from the centers of corresponding ones of the clusters of photosites.

15. An image sensing method, comprising:
dividing light into an array of light beams;
sensing the light beams at corresponding ones of clusters of photosites;
generating signals from the sensed light beams; and
reading the signals through sets of readout circuitry shared by respective groups of multiple ones of the photosites.

16. The method of claim 15, wherein the dividing comprises focusing the light beams on the photosites of corresponding ones of the clusters.

17. The method of claim 15, wherein the dividing comprises filtering the light to allow respective colors of light to pass through to the photosites of the corresponding ones of the clusters.

18. The method of claim 15, wherein each light beam is sensed at a respective cluster of four photosites.

19. A method making an image sensor, comprising:
forming an array of cells each comprising a respective photosite, wherein adjacent ones of the cells are arranged into respective groups of cells each sharing at least one readout circuit component and adjacent groups of cells form clusters of photosites; and
forming an array of optical elements each aligned with a corresponding one of the clusters of photosites and arranged to intercept light directed toward the photosites of the corresponding ones of the clusters.

20. The method of claim 19, wherein forming the array of optical elements comprises forming an array of color filters configured to allow respective colors of light to pass through to the photosites of the corresponding ones of the clusters; and further comprising forming an array of lenses each aligned with a corresponding one of the color filters, wherein each lens is configured to focus light onto the photosites of a corresponding one of the clusters.
